(19) United States
(12) Patent Application Publication
(10) Pub. No.: US 2005/0254533 A1
(43) Pub. Date: Nov. 17, 2005

(54) Arrangement and method for generating ultrashort laser pulses

(76) Inventors: Guenter Hollemann, Jena (DE); Bernd Braun, Jena (DE); Ulf Krause, Drackendorf (DE)

Correspondence Address: JORDAN AND HAMBURG LLP, 122 EAST 42ND STREET, SUITE 4000, NEW YORK, NY, 10168, US

(21) Appl. No.: 10/526,330

(22) PCT Filed: Aug. 29, 2003
(86) PCT No.: PCT/DE03/02899

§ 371 Date: Apr. 4, 2005

(30) Foreign Application Priority Data
Aug. 30, 2002 (DE) 102 40 599.9

(51) Int. Cl. H01S 3/10

(52) U.S. Cl. 372/25; 359/333

(57) ABSTRACT

The invention relates to an arrangement and a method for generating ultrashort laser pulses. The aim of the invention is to avoid the deterioration of the beam quality caused by the plurality of required revolutions, the accompanying loss of revolutions, and pulse broadening in regenerative amplifiers by means of a simpler and more cost-effective laser installation, and to provide ultrashort laser pulses with pulse repeat rates in an extended kHz range. In an installation consisting of a solid-state laser oscillator, a multi-stage laser amplifier which is arranged downstream therefrom and is used to increase the energy of pulses, and at least one switching element for selecting pulses from a pulse train provided by the solid-state laser oscillator, a small-signal gain higher than 10 is provided in an amplifying laser crystal in each amplification stage, the total small-signal gain produced by all amplifying laser crystals amounting to more than 100. In this way, ultrashort laser pulses having pulse lengths which are especially below 20 ps, pulse repeat rates between 1000 Hz and 10 MHz and pulse energies in the mJ range are generated, said ultrashort laser pulses being applicable in the fields of micromaterial machining and medicine.

The invention relates to generating ultrashort laser pulses with pulse lengths of less than 100 ps, pulse repetition rates in the range of 1000 Hz-10 MHz, and pulse energies in the mJ range.

There is an urgent need in micromaterials processing for such ultrashort pulse lasers (e.g., boring nozzles and laser-honing of tribologic surfaces), which in particular are based on solid state laser technology and are diode-pumped. Ultrashort pulse lasers can also be employed just as advantageously for medical applications in the field of ophthalmology (e.g. refractive corneal surgery) and dental medicine (e.g. processing of dental material).

The advantage of ultrashort pulse technology compared to acoustooptical Q-switched solid-state lasers with longer pulse durations of for instance 10 ns and longer is that quasi-“cold” removal of the material is made possible without a negative affect on the local surroundings by melt ejection and thermal heating. Thus, investigations have demonstrated that pulse durations of 5 ps-10 ps lead to an optimum result when boring metal materials (F. Dausinger, “Femtosecond Technology for Precision Manufacturing: Fundamental and Technical Aspects”, Proceedings of the International Congress on Laser Advanced Materials Processing (LAMP), 27-31 May 2002, Osaka, Japan (2002)).

In accordance with this publication, for instance, the following parameters are critical for “cold” material removal and an associated positive processing result: pulse lengths of less than 10 ps, pulse repetition rates of 10 kHz-100 kHz, and pulse energy of 0.1 mJ-1 mJ. It proves advantageous that the disadvantages that generally occur during material processing of metals with “true” fs pulses can be avoided, such as structuring of borehole walls, field strength punctures to air, complex plasma generation, etc.

Arrangements that are known from W. Koechner, “Solid-State Laser Engineering”, Fifth Edition, Springer Series in Optical Sciences, Springer, Berlin, 1999 and that are for generating energy-rich ultrashort laser pulses, comprising a mode-coupled Ti:sapphire laser oscillator and a regenerative amplifier downstream in the beam, select from a series of short oscillator pulses of low energy and a pulse repetition rate of e.g. typically 100 MHz laser pulses with a lower pulse repetition rate and amplify the selected pulses with the regenerative amplifier.

Regenerative amplifiers comprise for instance an end-pumped laser crystal and a mirror system that is designed as a stabile resonator. Within the resonator they employ a Pockels cell as active circuit element that with low losses actively couples and decouples the laser pulses and thus determines the pulse cycle number within the resonator. One system-related disadvantage of regenerative amplifiers is the deterioration in beam quality and thus the cycle losses associated with required cycles (typically 5-100). Frequently there is also a pulse enlargement from the number of cycles (“gain narrowing”). In addition, high pulse energies and pulse peak powers occur in regenerative amplifiers, and these impose very high demands on the optical quality of materials, surface polish, and coating of the optical components.

Furthermore, Pockels cells are in principle problematic due to high voltage operation, since complex electronics are required for pulse repetition rates of 1 kHz and higher. In the past there has been no technically acceptable solution in terms of Pockels cells for pulse repetition rates greater than 50 kHz. Additional disadvantages have to do with the strong electromagnetic emissions from the modulated high voltage.

Recently (D. Müller, S. Erhard, A. Giesen, “High Power Thin Disk Yb:YAG Regenerative Amplifier”, OSA TOPS Vol. 50, Advanced Solid-State Lasers, 2001 Optical Society of America), regenerative amplifiers based on disk lasers were also investigated, but despite many technical enhancements on an individual level, ultrashort pulse lasers remain challenging in terms of the quality of optical components and regenerative amplifiers can only be operated when using EOM up to 10 kHz. Femtosecond laser systems are therefore not to be considered suitable for industry despite very promising broad application results.

The object of the invention is to avoid in regenerative amplifiers the deterioration in beam quality and the cycle losses and pulse enlargements associated with it caused by the required number of cycles, using a simpler and more cost-effective laser structure. Ultrashort laser pulses with pulse repetition rates in an expanded kHz range and with pulse energies in the mJ range should also be provided.

In accordance with the invention, this object is attained by an arrangement for generating ultrashort laser pulses, containing a solid-state laser oscillator for providing a pulse sequence and a downstream multistage laser amplifier for increasing the pulse energy of pulses that are selected by at least one circuit element from the pulse sequence with a reduced pulse repetition rate compared to the pulse sequence, whereby the laser amplifier has no resonator and is free of active circuit elements with respect to the pulse to be amplified and has no more than one double pass of the pulse to be amplified. For the invention it is essential that one small-signal amplification of more than 10 is provided for each amplifier stage in a laser crystal to be amplified, whereby the total small-signal amplification caused by all amplified laser crystals is more than 100.

It is advantageous when the small-signal amplification ensures the achievement of a pulse energy of more than 10 μJ.

Additional advantageous designs are contained in the subordinate claims.

Due to the very high total small-signal amplification of more than 100, seeding can be accomplished with very small powers, which greatly simplifies the formation of ultrashort pulses. Thus, given small-signal amplification of for instance 10⁶, adequate storability of the active amplifier medium, and an input pulse energy of 10 nJ-100 nJ, an increase in the pulse energy in the range of 0.1 ml-5 mJ, the range that is essential for material processing, is possible in one simple beam passage using the laser amplifier.

Not using a regenerative amplifier and its resonator structure is also connected to the advantage that complex circuit regimes of active pulse coupling and decoupling no longer have to be used after multiple cycles. Consequently the electro-optical modulator, which is absolutely required in the regenerative amplifier, can also be replaced by a circuit element that does not have the aforesaid disadvantages. Nor must the high demands in terms of low transmission losses be placed on the replacing circuit element any longer.

Above all it is advantageous for a simplified structure of the circuit element for selecting the laser pulses. This can be arranged as an individual acoustooptical modulator or as a pair thereof between the solid-state laser oscillator and the amplifier input of the laser amplifier.

Since the circuit element is arranged outside of the laser amplifier, the laser amplifier, for which no laser resonator is provided in the present invention, also does not have any active beam switch element, in contrast to a regenerative amplifier. The preferably employed, simply constructed, and thus cost-effective acoustooptical modulator is thus employed exclusively as a “pulse picker”.

In one advantageous embodiment the acoustooptical modulator can be triggered by a photodiode that determines the selection of the pulses in connection with an electronic counter. This means that the pulse repetition rate can be varied by setting the pulses to be selected in a timing unit.

Naturally the invention does not exclude the situation in which an electro-optical modulator is employed as circuit element and is arranged between the solid-state laser oscillator and the amplifier input of the laser amplifier. In contrast to an arrangement in a regenerative amplifier, however, such a circuit element is only subjected to a minor optical power load.

For avoiding interference from the laser amplifier in the solid-state laser oscillator, it is advantageous to arrange a Faraday isolator between the solid-state laser oscillator and the laser amplifier or to provide the circuit element additionally as optical isolator between the solid-state laser oscillator and the laser amplifier. For avoiding reflected radiation from the application into the laser amplifier, a Faraday isolator can also be provided additionally or individually in the beam path downstream of the laser amplifier. Such a protective measure also facilitates arrangement of polarizer and a lambda quarter plate downstream of the laser amplifier.

The invention provided preferably for diode laser-pumped, mode-coupled solid-state laser oscillators is not limited thereto, but rather is also suitable for Q-switched, highly repeating pulsed laser oscillators, passive Q-switched laser oscillators, and for microchip lasers and pulsed diode lasers.

In one very high amplification it is of particular advantage to provide an auxiliary resonator for a wavelength other than that of the pulse to be amplified or the orthogonal polarized components of the pulse, that contains the laser amplifier as laser-active element and that stimulates during increasing inversion in the amplifying laser crystal and limits it to a low value. Even using this measure the laser amplifier remains quasi-resonator-free, since it is not effective for the wavelength and the polarization of the pulse to be amplified.

The inventive amplifier arrangement can also be used very advantageously for generating ultrashort laser pulses in the UV range in that one or more non-linear optical crystals are arranged downstream for wavelength transformation.

The aforesaid object is furthermore inventively attained using a method for generating ultrashort laser pulses by selecting pulses with lower pulse repetition rates from a primary pulse sequence and by amplifying the selected pulses with a multistage laser amplifier that has no resonator with regard to the pulse to be amplified and from which decoupling of the amplified pulses occurs free of active switching procedures, whereby the amplification is connected with no more than one double pass by amplifying media provided in the amplifier stages and whereby the selected pulses in every amplifier stage are amplified with small-signal amplification of more than 10 but at least with a total small-signal amplification of more than 100.

The invention provides a laser beam source that is suitable for industry, that has a simple structure, that delivers ultrashort laser pulses in the ps range and with pulse energies in the mJ range, and the pulse repetition rates in the kHz range of which leave adequate time between two pulses for thermal relaxing of processed material. In that this prevents the heat from flowing into the workpiece, there is no undesired thermal damage in the vicinity of direct interaction.

The invention will be explained in greater detail in the following using the drawings.

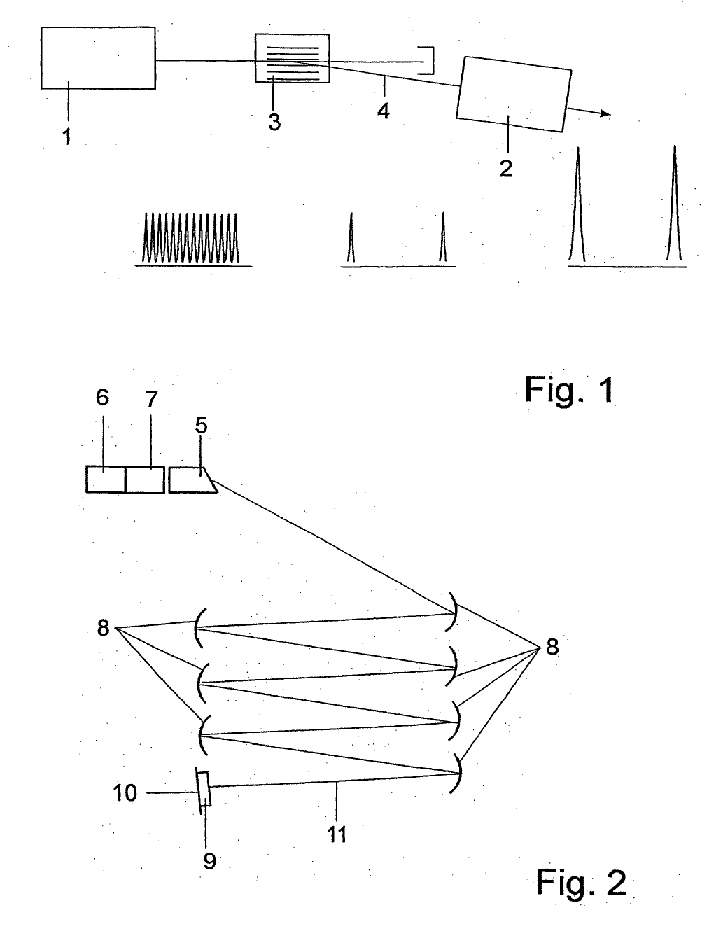

FIG. 1 illustrates the overall structure of an arrangement for generating ultrashort laser pulses, with a schematic representation of the pulses present;

FIG. 2 illustrates the structure of a mode-coupled solid-state laser oscillator;

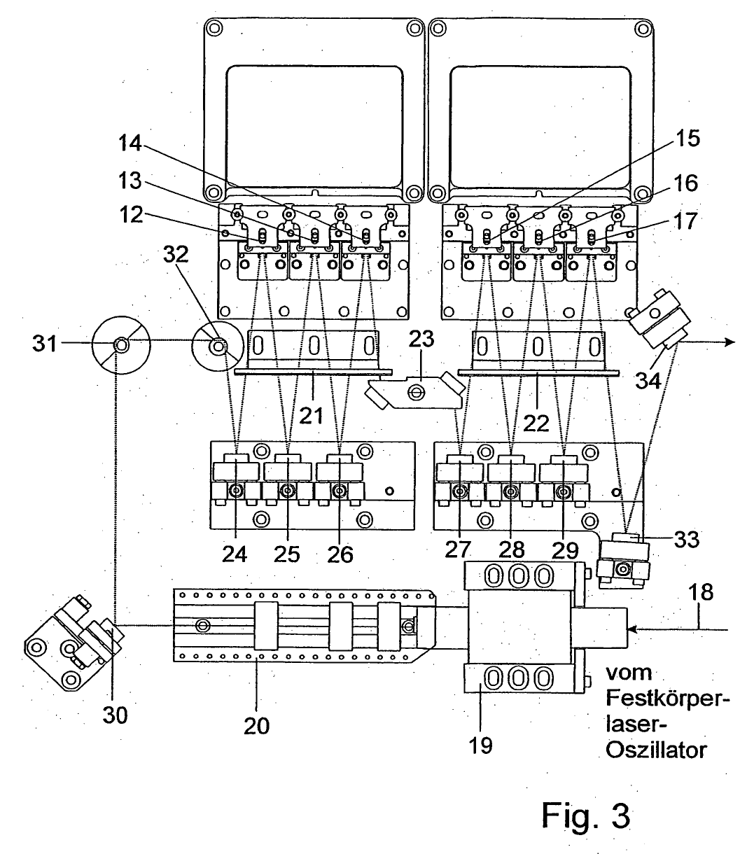

FIG. 3 illustrates the structure of a laser amplifier that is downstream of the mode-coupled solid-state laser oscillator;

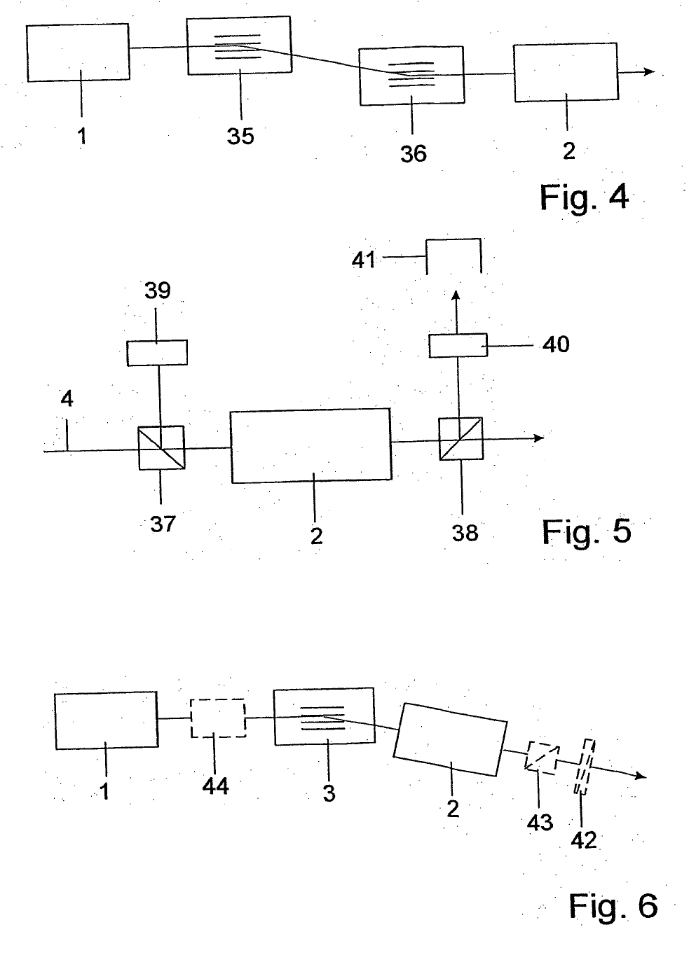

FIG. 4 illustrates an arrangement for generating ultrashort laser pulses, with two acoustooptical modulators as circuit elements;

FIG. 5 illustrates the structure of an auxiliary resonator;

FIG. 6 illustrates an arrangement for generating ultrashort laser pulses with devices to protect against receding radiation.

In the arrangement illustrated in FIG. 1, an acoustooptical modulator 3 is arranged between a mode-coupled solid-state laser oscillator 1 and the amplifier input of a laser amplifier 2 as preferred circuit element for selecting pulses from a pulse sequence provided by the solid-state laser oscillator 1.

The beam 4 diffracted when the acoustooptical modulator is inserted in the first order is coupled into the laser amplifier 2. The leading edges of for instance 10 ns, which can be attained with conventional modulators, are adequate for selecting an individual pulse from a pulse train at pulse repetition rates of up to 100 mHz (pulse interval 10 ns). If work is performed with yet another acoustooptical modulator (FIG. 4), this leads to a reduction of power within the modulator, to sharper focusing, and to even shorter switching times.

The acoustooptical modulator 3 employed as “pulse picker” can be triggered by a fast photodiode that detects the pulse train and counts out every 100th or every 1000th pulse by means of fast electronics and opens the time window for this pulse in a synchronized manner. This also makes possible quasi-continuous variation of the pulse repetition rate, since the number selected pulses per unit of time is freely selectable.

In addition, the “pulse picker” is suitable for assuming the function of optical isolation, since it closes again after pulse selection.

The pulse repetition rate can be changed in limits with constant mean power. For instance, with Nd:YVO₄, the mean power is reduced by only 5% when the pulse repetition rate is reduced from 500 kHz to 50 kHz.

The solid-state laser oscillator 1 illustrated in FIG. 2 contains an Nd:YVO₄ laser crystal 5 that is diode-pumped using a diode laser 6 with associated pump optics 7. The solid-state laser oscillator 1 is folded several times by deviation mirrors 8 and works with a saturable semiconductor absorber 9 and a terminal mirror 10. In the structure in accordance with FIG. 2, there are different options for beam decoupling. Thus a dichroitic mirror can be arranged between the laser crystal 5 and the pump optics 7, for instance.

A pulse energy of 170 nJ results with the diode-pumped Nd:YVO₄ oscillator employed in the present exemplary embodiment with a pulse repetition rate of 30 mHz (pulse interval 33 ns), output power of 5 W, and pulse duration of 8 ps.

The acoustooptical modulator 3, the pulse rise time of which is 10 ns, selects every 50th pulse with a diffraction efficiency of more than 80% so that a mean input power at the amplifier input of the laser amplifier 2 is greater than 5 mW at 60 kHz pulse repetition rate.

The laser amplifier illustrated in FIG. 3, the individual amplifier stages of which have already been described in detail in DE 100 43 269 A1 and reference to which is made here, comprises six such amplifier stages with a serial arrangement of six laser crystals 12-17 as amplifying media that are diode-pumped by the same number of associated high-performance diode lasers (covered in FIG. 3). In contrast to the regenerative amplifiers used in the past for generating ultrashort pulses, the amplifier stages of the laser amplifier used in the invention have no resonator structure. The pump radiation exiting from the high-performance diode lasers is first collimated and then focused into the laser crystals 12-17, which for achieving a highly stimulated emissions effective cross-section in the present exemplary embodiment are Nd:YVO₄ crystals. Due to the high beam quality of the pump radiation in the fast axis direction, a highly elliptical pump focus occurs with dimensions of about 0.1 mm×2.0 mm, resulting at an absorbed pump power of 18 W in a very high pump power density and thus in very high small-signal amplification. This is more than 10 per amplifier stage, so that total small-signal amplification of greater than 10⁶ results for the six provided amplifier stages.

In addition to Nd:YVO₄ crystals, Nd:Gd:YVO₄ crystals and other Nd-doped crystals can be used advantageously.

For avoiding interference from the laser amplifier in the solid-state laser oscillator 1, a round laser beam 18 exiting from the solid-state laser oscillator 1 runs through a Faraday isolator 19 with e.g. 30-60 dB damping and irradiates mode-adapted through a lens combination 20 all six laser crystals 12-17 sequentially on a zigzag path. In addition, for additional adapting to the highly elliptical pump focus, the laser beam 18 is focused into the laser crystals 12-17 by means of cylinder lenses 21, 22 so that the laser beam 18 that has been collimated in the tangential plane passes through the laser crystals 12-17 in the sagittal plane with a highly elliptical focus. The present laser amplifier is in two parts, whereby both parts are optically joined via a periscope 23.

After its second pass through the cylinder lenses 21, 22, the laser beam 18 is also recollimated in the sagittal plane with the same elliptical cross-section as prior to the first pass through the cylinder lenses 21, 22.

Thus mode-adapted beams of the pump radiation and the laser radiation 18 to be amplified pass through the laser crystals 12-17, whereby due to the radiated elliptical pump radiation a thermal lens with different thickness is formed in planes that are perpendicular to one another. Focused in the plane with highly thermal lens, the laser radiation 18 is directed into each of the laser crystals 12-17, whereby a forming beam waist is in the region of the thermal lens.

Folding mirrors 24-29 ensure the zigzag path and can also be used to adjust the beam dimensions in the slow axis direction. Additional deflection elements 30-34 further the construction of a compact arrangement.

After exiting the laser amplifier, the laser beam 18 is adjusted to the desired beam parameters for the provided application by means of a lens arrangement (not shown) comprising e.g. cylinder lenses.

Mean powers of 40 W-60 W can be attained in saturated operations with the six-stage laser amplifier in accordance with FIG. 3 at small-signal amplification of 1,000,000. The lifetime of the excited metastable laser level of Nd:YVO₄ is 90 μsec, which corresponds to a pulse energy of greater than 1.3 mJ. The pulse length is not changed, since no “gain narrowing” occurs in the laser amplifier given relatively long pulses of 8 ps pulse duration. Pulse peak power is thus 160 MW.

With regard to the data on necessary saturated amplification of the laser amplifier, it can be seen in the following table that, based on the lifetime of the above laser level and an amplified spontaneous emission (ASE), the amplification reduces in saturation depending on the pulse repetition rate, analogous to Q-switched lasers and laser amplifiers of Q-switched oscillators with pulse lengths in the ns range.

| | | Required saturated ampli- |
|---|---|---|
| Pulse repetition | Mean power in accordance | fication for 40 W mean |
| rate | with pulse picker | power |
| 1 kHz | 0.17 mW | 2.4 × 10⁵ |
| 10 kHz | 1.7 mW | 2.4 × 10⁴ |
| 100 kHz | 17 mW | 2.4 × 10³ |
| 1 MHz | 170 mW | 2.4 × 10² |

The pump beam cross-sections with the laser amplifier illustrated in FIG. 3 compared to a pump arrangement with fiber-coupled diode laser (N. Hodgson, D. Dudley, L. Gruber, W. Jordan, H. Hoffmann, “Diode End-pumped, TEM₀₀ Nd:YVO₄ Laser with Output Power Greater than 12 W at 355 nm”, CLEO 2001, Optical Society of America, Techn. Digest, 389, (2001) can be taken from the following table. The pump beam cross-sections and thus the attainable pump power density are absolute requirements for attaining high small-signal amplification (W. Koechner, “Solid-State Laser Engineering”, Fifth Edition, Springer Series in Optical Sciences, Springer, Berlin, 1999).

| | | Elliptical pump cross- |
|---|---|---|
| Parameter | Fiber-coupled diode | section |
| Beam diameter x | 0.6 mm | 2.2 mm |
| Beam diameter y | 0.6 mm | 0.05 mm |
| Pumped area (focus) | 0.28 mm² | 0.09 mm² |
| Effective cross-section | 0.56 mm² | 0.17 mm² |
| Small-signal amplification | 2 | 15 |

The effective average weighted cross-section along the absorption length in the laser crystal is called the effective cross-section. A factor 2 was assumed for simplifying in terms of the minimum cross-sectional area.

The arrangement in FIG. 4 depicts another embodiment of the invention that uses two acoustooptical modulators 35, 36 as circuit elements, the solid-state laser oscillator 1 generates a pulse train with a pulse repetition rate of for instance 200 MHz. The first acoustooptical modulator 35 pares the pulse train into pulse packets with a pulse packet repetition rate of for instance 200 kHz, whereby each pulse packet contains 10 pulses. This reduces the optical mean power for the second acoustooptical modulator 36 to 1% so that focusing can be very small and thus fast switch edges are made possible for cutting out an individual pulse.

In another embodiment in accordance with FIG. 5, an auxiliary resonator is provided, but it is not effective for the wavelength λ₁ of the oscillator beam, which is provided for further use. The auxiliary resonator contains two dichroitic beam splitters 37, 38 that are adjacent to the laser amplifier 2 and that are transmitting for the wavelength λ₁ and are highly reflecting for a second wavelength λ₂ that can also be amplified with the laser amplifier 2 (or for another polarization). Of two resonator mirrors 39, 40 forming the auxiliary resonator, for instance the one resonator mirror 39 is highly reflecting for the wavelength λ₂ and the other resonator mirror 40 acts as decoupler for the wavelength λ₂.

The auxiliary resonator, the lasing threshold of which is set by the selection of the decoupling degree of the resonator mirror 40, stimulates oscillation when the amplification in the amplifying medium of the laser amplifier 2 reaches a critical value and thus limits the maximum small-signal amplification. This can effectively prevent an interfering continuous wave background for pulsed radiation that occurs through amplified spontaneous emission (ASE) e.g. when the solid-state laser oscillator 1 has a pulse repetition rate that is too low or is turned off.

At the same time, a thermally stationary condition is attained more rapidly after the solid-state laser oscillator 1 is connected to the laser amplifier 2. The laser radiation exiting from the auxiliary resonator with a wavelength λ₂ as a rule is not directly useful and can for instance be captured in a beam trap 41.

The auxiliary resonator can also be used to suppress the interfering exaggeration of the first pulse, which also originates in the inversion in the laser-active medium that is elevated relative to stationary operation.

For protecting the amplifying elements in the laser amplifier 2 and the solid-state laser oscillator 1 from receding radiation from an application, protective devices can be provided in accordance with FIG. 6. One appropriate measure is for instance a lambda quarter plate 42 that is placed e.g. behind the amplifier output and that has a polarizer 43. For this purpose, it can also be possible to place a Faraday isolator 44 downstream of the solid-state laser oscillator 1, as already contained in FIG. 3, which Faraday isolator also offers protection from receding radiation from the laser amplifier 2.

1. Arrangement for generating ultrashort laser pulses comprising:
a solid-state laser oscillator;
a multistage laser amplifier; and
at least one circuit element for selecting pulses from the pulse sequence with a reduced pulse repetition rate compared to the pulse sequence,
said laser amplifier having no resonator and being free of active circuit elements with respect to the pulse to be amplified and having at least one double pass of the pulse to be amplified,
wherein a small-signal amplification of more than 10 is provided for each amplifier stage in an amplifying laser crystal the total small-signal amplification caused by all amplifying laser crystals being greater than 100.

2. Arrangement in accordance with claim 1, said laser amplifier comprising a laser-active element and being arranged in a resonator that is effective for a second wavelength (λ2) other than a first wavelength (λ1) of the pulse to be amplified or for a second polarization component that is oriented orthogonal to a first polarization component of the pulse.

3. Arrangement in accordance with claim 2, further comprising two dichroitic beam splitters adjacent to said laser amplifier and two reasonator mirrors, said beam splitters being transmitting for said first wavelength (λ1) or for said first polarization component of said pulse to be amplified and highly reflecting for said second wavelength (λ2) or said second polarization component, said second wavelength (λ2) or said second polarization component being directed by said beam splitters to the two resonator mirrors, one being highly reflecting for said second wavelength (λ2) or said second polarization component and the other being adapted for decoupling said second wavelength (λ2) or said second polarization component.

4. Arrangement in accordance with any of claims 1 through 3, wherein said circuit element comprises an acoustooptical modulator and is arranged between said solid-state laser oscillator and said amplifier.

5. Arrangement in accordance with claim 4, wherein said acoustooptical modulator is triggered by a photodiode that determines the selection of the pulses in conjunction with an electronic counter.

6. Arrangement in accordance with any of claims 1 through 3, further comprising two acoustooptical modulators arranged as circuit elements one after the other between said solid-state laser oscillator and said amplifier.

7. Arrangement in accordance with claim 1, wherein the pulse repetition rate is variable by adjusting the pulses to be selected in a time unit.

8. Arrangement in accordance with any of claims 1 through 3, wherein said circuit element comprises an electrooptical modulator and is arranged between said solid-state laser oscillator and said laser amplifier.

9. Arrangement in accordance with any of claims 1 through 3, wherein said circuit element comprises an optical isolator between said solid-state laser oscillator and said laser amplifier.

10. Arrangement in accordance with any of claims 1 through 3, further comprising a Faraday isolator arranged between said solid-state laser oscillator and said laser amplifier.

11. Arrangement in accordance with any of claims 1 through 3, wherein said solid-state laser oscillator is diode-pumped and mode-coupled.

12. Arrangement in accordance with any of claims 1 through 3, wherein said solid-state laser oscillator comprises a Q-switched, highly-repetitive pulsed oscillator.

13. Arrangement in accordance with any of claims 1 through 3, wherein said solid-state laser oscillator comprises a passive Q-switched oscillator.

14. Arrangement in accordance with any of claims 1 through 3, wherein said solid-state laser oscillator comprises a pulsed diode laser.

15. Arrangement in accordance with any of claims 1 through 3, wherein said solid-state laser oscillator comprises a pulsed laser.

16. Arrangement in accordance with any of claims 1 through 3, further comprising a polarizer and a lambda quarter plate or a Faraday isolator arranged downstream of said laser amplifier.

17. Arrangement in accordance with any of claims 1 through 3, further comprising at least one non-linear optical crystal for wavelength transformation arranged downstream of said laser amplifier.

18. Method for generating ultrashort laser pulses by selecting pulses with reduced pulse repetition rates from a primary pulse sequence and by amplifying the selected pulses with a multistage laser amplifier that has no resonator with respect to the pulse to be amplified and from which the amplified pulses are decoupled free of active switching procedures, whereby the amplification is connected to no more than one double pass by amplifying media provided in the amplifier stages and whereby the selected pulses in each amplifier stage are amplified with small-signal amplification of more than 10, but at least however with total small-signal amplification of more than 100.
